(19) United States
(12) Patent Application Publication
(10) Pub. No.: US 2004/0263645 A1
(43) Pub. Date: Dec. 30, 2004

(54) Sequential scan imaging device

(75) Inventors: Fujio Okada, Saitama-ken (JP); Mitsuhisa Nakagawa, Kanagawa-ken (JP); Keiichi Negishi, Kanagawa-ken (JP)

Correspondence Address: Clifford Chance US LLP, 31 West 52nd Street, New York, NY, 10019-6131, US

(73) Assignee: Fuji Photo Optical Co., Ltd.

(21) Appl. No.: 10/893,083

(22) Filed: Jul. 15, 2004

Related U.S. Application Data
(63) Continuation of application No. 09/409,659, filed on Sep. 30, 1999, now abandoned.

(30) Foreign Application Priority Data
Sep. 30, 1998 (JP) 277321/1998

(51) Int. Cl. H04N 5/335

(52) U.S. Cl. 348/231.99

(57) ABSTRACT

In an electronic endoscope using an imaging element comprising a colour filter for pixel binning, it is possible to carry out outline enhancement processing, zoom processing, and the like, to a high degree of detail. An optical chopper 36 in the form of a semi-circular plate is caused to rotate at 1/30th second per revolution, and images are captured in time periods of 1/60th second separated by light shielding intervals of 1/60th second. An imaging signal for the odd-numbered lines and the even-numbered lines is read out successively from the imaging element at 1/60th second intervals, and stored in memories 23 and 24, respectively. By means of mixing circuit 25, odd-numbered field data is obtained by mixing imaging data for the even-numbered lines and their subsequent odd-numbered lines, and even-numbered field data is obtained by mixing imaging data for the odd-numbered lines and their subsequent even-numbered lines, whereupon the field data undergoes colour signal processing, and the like, in the DVP 27, and is then stored temporarily in the third memory 28. This data is converted to sequential scan imaging data by reading out the data repeatedly in alternate sequence whilst switching the number of the binning line. DVP 31 implements outline enhancement processing, zoom processing, and the like, using this sequential scan imaging data.

### BACKGROUND OF THE INVENTION

1. Field of the Invention

The present invention relates to an imaging device, and more particularly to an imaging device comprising imaging elements, such as CCDs, which is used as a surveillance camera, a medical camera, or the like.

2. Description of the Related Art

Video cameras for capturing images (hereinafter simply called “cameras”) comprising imaging means, such as CCD imaging elements, or the like, are known in the prior art. Currently, such cameras are employed not only for broadcast and domestic use, but are also used widely as surveillance cameras, medical cameras, and the like.

When a colour image is captured using a camera of this kind, then in order to obtain a colour signal (comprising, for example, three primary colour signals, R, G, B) from a single CCD imaging element, using a single-plate camera, for example,) a method is adopted whereby colour filters are superposed in pixel units arranged numerously in a two-dimensional shape, and colour information is obtained by multiplexing it with brightness information, the brightness signal and the three primary colour signal (or a signal conforming to same) being separated from each other. For the colour filters, a colour filter array comprising 3-4 types of colour (primary colours or complementary colours) arranged in a dot fashion is used.

The separated three primary colour signal then undergoes white balance (WB) correction, gamma (γ) correction for offsetting the γ characteristics of the cathode tube, high-level suppression processing, such as KNEE processing or white clipping (WC), and the like, for each colour signal, whereupon it is supplied along with the brightness signal to an output circuit for carrying out matrix processing and encoding processing, and then converted to an RGB signal of a prescribed level or a video signal conforming to a broadcast standard such as the NTSC system, or the like.

Furthermore, currently, outline enhancement processing, image zoom processing (enlargement and reduction processing), and the like, is sometimes implemented before outputting the signal, in order to raise visual resolution.

In a conventional imaging device, imaging signals are read out from the CCD imaging elements by carrying out interlace scanning. For example, in an imaging element using an RGB primary colour filter array based on a green check system, as typified by the Bayer system, after initial exposure, the imaging signal for the odd-numbered field comprising odd-numbered lines, 1, 3, 5, . . . , is read out, and after the subsequent exposure, the imaging signal for the even-numbered field comprising even-numbered lines, 0, 2, 4, . . . , is read out. Furthermore, in an imaging element which combines pixels using a complementary colour filter array, known as a frequency interleave system or a colour difference sequential combining and read-out system, after the initial exposure, an imaging signal for the odd-numbered fields comprising a combined signal for even-numbered lines and their subsequent odd-numbered lines, such as 0+1, 2+3, 4+5, . . . , is read out, and after the next exposure, an imaging signal for the even-numbered fields comprising a combined signal for the odd-numbered lines and their subsequent even-numbered lines, such as 1+2, 3+4, 5+6, . . . , is read out. In other words, a combined signal for two lines of CCD imaging elements is taken as the imaging signal for a single line in each field.

In cases where imaging elements are used in any of the systems described above, an image signal for one frame is created by interlace scanning on the basis of the imaging signal for the odd-numbered field and the imaging signal for the even-numbered field read out as described above, and this image signal is output to a TV monitor, or the like.

Here, the aforementioned outline enhancement processing, or the like, is generally carried out in field units on the basis of an image signal wherein odd-numbered fields and even-numbered fields are read out successively from the imaging elements.

However, if outline enhancement processing (in particular, in the vertical scanning direction) and image zoom processing are carried out in field units, since the image signal for each field is created from signals for non-consecutive lines 1, 3, 5, . . . , etc., it is not possible to use data for adjacent lines in the frame image as line data for use in these processing steps, and consequently, image processing becomes coarse, image distortions occur in detailed areas, and image quality falls. In devices which output only moving images, such deterioration in image quality does not often present a significant problem, but in cameras used in medical equipment, such as endoscopes, or the like, it is necessary to output a stationary image, or “hard copy”, and hence image deterioration of this kind becomes a problem.

In order to resolve problems such as image deterioration of this kind, a method may be conceived whereby a sequential scan frame image signal is generated on the basis of an odd-numbered field imaging signal and an even-numbered field imaging signal obtained as described above, and outline enhancement processing or zoom processing is carried out in frame units.

However, in the conventional imaging signal read-out method described above, since the imaging signal for the odd-numbered field is obtained after the initial exposure and the imaging signal for the even-numbered field is obtained after the subsequent exposure, there is a time lag in exposures between the imaging signals for the two fields which form the image signal for one frame. Therefore, if there is a relative movement between the imaging device and the object being imaged, a problem arises in that a frame image signal having degraded image quality producing blurring and colour deviation will be generated and image quality will be degraded further if outline enhancement processing and image zoom processing are carried out on the basis of this signal.

### SUMMARY OF THE INVENTION

The present invention was devised in view of the foregoing, an object thereof being to provide an imaging device which does not give rise to deterioration of image quality, as in the prior art, when signal processing, such as outline enhancement processing, image zoom processing, or the like, is carried out.

The imaging device according to the present invention comprises: an imaging element, wherein a plurality of pixels are arranged in a plurality of lines, which is capable of reading out imaging signals captured by means of the pixels, line by line; light exposure controlling means for alternately repeating steps of exposure and non-exposure of the imaging element to light; driving means for driving the imaging element in such a manner that an imaging signal is output for the pixels in each line of one of either the odd-numbered lines or the even-numbered lines, from the pixels in the plurality of lines, for a prescribed time period after the exposure, whereupon an imaging signal is output for the pixels in each line of the other of either the odd-numbered lines or the even-numbered lines, before the subsequent exposure; first storing means for storing an imaging signal for each of the one group of lines and second storing means for storing an imaging signal for each of the other group of lines (naturally, it is also possible to provide a single storing means comprising both functions); and sequential scanning means for obtaining a sequential scan imaging signal by repeatedly reading out the imaging signal for each line stored in the first storing means and the imaging signal for each line stored in the second storing means, in alternating sequence.

Furthermore, the imaging device according to the present invention comprises: an imaging element for capturing colour images, wherein a plurality of pixels are arranged in a plurality of lines and a plurality of colour filters for pixel binning are positioned in units of the pixels, which is capable of reading out imaging signals captured by means of the pixels, line by line; light exposure controlling means for alternately repeating steps of exposure and non-exposure of the imaging element to light; driving means for driving the imaging element in such a manner that an imaging signal is output for the pixels in each line of one of either the odd-numbered lines or the even-numbered lines, from the pixels in the plurality of lines, for a prescribed time period after the exposure, whereupon an imaging signal is output for the pixels in each line of the other of either the odd-numbered lines or the even-numbered lines, before the subsequent exposure; first storing means for storing an imaging signal for each of the one set of lines and second storing means for storing an imaging signal for each of the other set of lines (naturally, it is also possible to provide a single storing means comprising both functions); and sequential scanning means for obtaining a sequential scan imaging signal by repeatedly using, in alternating sequence, a pixel-binned signal for a first binning line, wherein the imaging signal for the pixels of each even-numbered line is combined with the imaging signal for the pixels of each subsequent odd-numbered line which correspond to the pixels of the even-numbered line, and a pixel-binned signal for a second binning line, wherein the imaging signal for the pixels of each odd-numbered line is combined with the imaging signal for the pixels of each subsequent even-numbered line which correspond to the pixels of the odd-numbered line.

Desirably, the imaging device according to the present invention further comprises outline enhancement processing means for implementing outline enhancement processing, or enlargement and reduction (zoom) processing means for implementing enlargement and reduction processing of the image, on the basis of the sequential scan imaging signal. Naturally, it is more desirable if the imaging device comprises both of these functions.

Moreover, desirably, the imaging device according to the present invention further comprises scan converting means for generating a sequential scan image signal for a personal computer interface, or the like, or an interlaced scan image signal for a TV system, or the like, on the basis of the sequential scan imaging signal. Naturally, it is more desirable if this processing is based on a sequential scan imaging signal that has undergone outline enhancement processing or enlargement and reduction processing.

According to the imaging device relating to the present invention, a sequential scan imaging signal is obtained using an imaging element capable of reading out an imaging signal line by line, repeating a process of alternately exposing and not exposing the imaging element, whilst reading out imaging signals for odd-numbered lines and even-numbered lines independently and storing these signals temporarily in storage means, and repeatedly reading out the stored imaging signals for each set of lines, in alternating sequence. This means that by using a sequential scan imaging signal of this kind, it is possible to carry out signal processing in frame units based on exposures of the same time period, in other words, signal processing using adjacent lines in a frame image, in contrast to conventional signal processing in field units, and consequently, finer (more detailed) processing can be carried out than in the prior art. This advantage is particularly notable in outline enhancement processing and image zoom processing.

Moreover, by using an imaging element for colour imaging which comprises a plurality of colour filters for combining pixels arranged in pixel units and is capable of reading out imaging signals line by line, it is also possible to achieve similar advantages in an imaging device for carrying out colour signal processing based on a colour difference sequential combining and read-out system.

### BRIEF DESCRIPTION OF THE DRAWINGS

FIG. 1 is a circuit block diagram wherein an imaging device according to an embodiment of the present invention is applied to an electronic endoscope;

FIG. 2 is a compositional diagram of a colour filter for an imaging element used in the aforementioned electronic endoscope;

FIG. 3 is a diagram showing the contents of imaging data created by the circuitry from the imaging element to the third memory in the aforementioned electronic endoscope;

FIG. 4 is a diagram illustrating the principal operations of the aforementioned electronic endoscope;

FIG. 5 is a circuit block diagram of an electronic endoscope using an imaging element having a colour filter of a different composition;

FIG. 6 is a compositional diagram of a colour filter for an imaging element having the aforementioned colour filter of a different composition; and

FIG. 7 is a diagram illustrating the principal operations of the aforementioned electronic endoscope using an imaging element having a colour filter of a different composition.

### DETAILED DESCRIPTION OF THE PREFERRED EMBODIMENTS

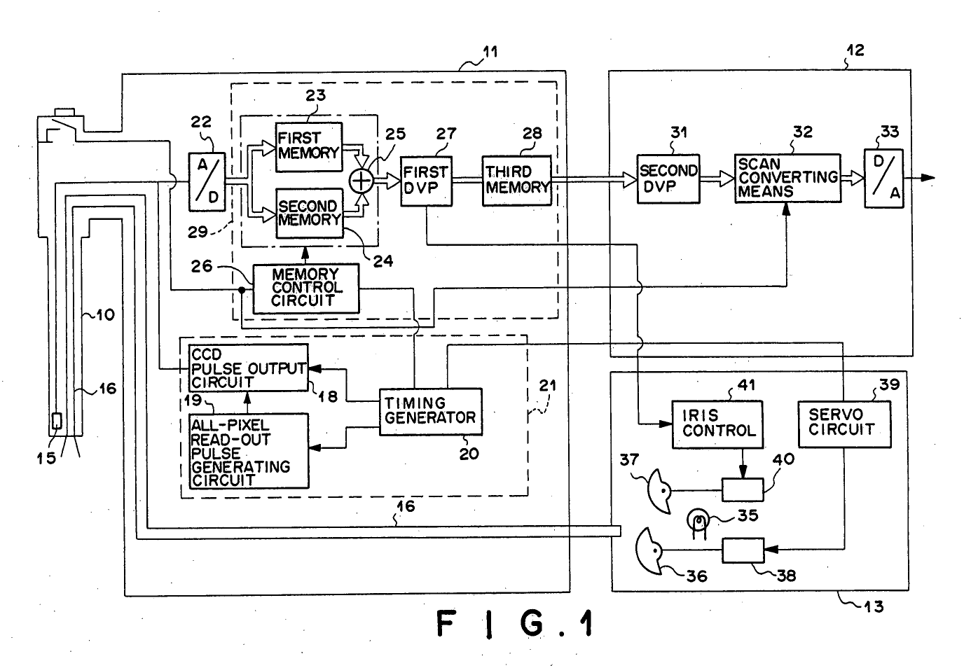

Below, an embodiment of the present invention is described in detail with reference to the drawings. FIG. 1 shows a circuit block diagram wherein an imaging device according to an embodiment of the present invention is applied to an electronic endoscope.

As shown in FIG. 1, this electronic endoscope 1 comprises a scope end section 10, a scope main unit 11, a processor section 12, and a light source section 13. A CCD imaging element 15 is provided in the scope end section 10, along with a light guide 16 which guides illumination light generated by the light source section 13 to the tip of the scope end section 10.

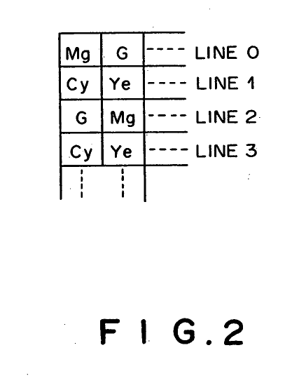

The CCD imaging element 15 comprises a plurality of pixels arranged in a plurality of lines, and a plurality of colour filters for combining pixels in the array configuration shown in FIG. 2 is arranged in pixel units. In other words, as shown in FIG. 2, Mg (magenta), G (green), Cy (cyan) and Ye (yellow) are arranged in pixel units, as shown in FIG. 2. This CCD imaging element 15 is based on an interline transfer system, and it is capable of reading out imaging signals captured by the pixels, line by line, by means of a drive pulse control method.

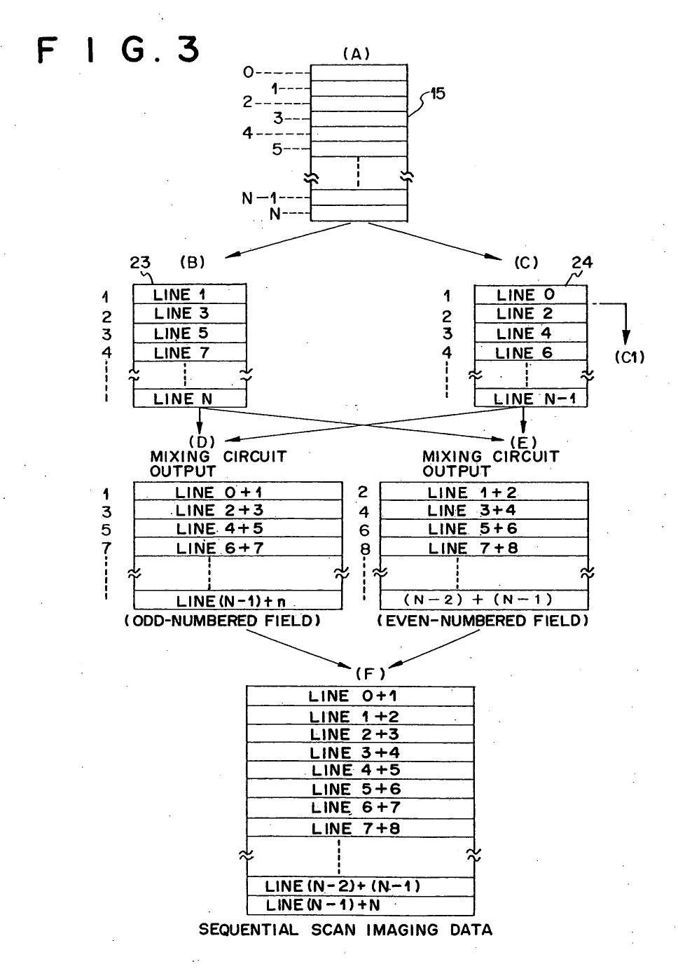

A pulse output circuit 18 for outputting drive pulses for driving the imaging element 15, an all-pixel read-out pulse generating circuit 19 and a timing generator 20 are provided in the scope main unit 11. The accumulated data for all pixels gathered by the imaging element 15 in one exposure is divided into odd-numbered lines and even-numbered lines, and a pulse (read-out pulse) for reading out data line by line is generated and input to the pulse output circuit 18. The pulse output circuit 18 implements control whereby the imaging signal for the odd-numbered lines and the imaging signal for the even-numbered lines are read out separately from the imaging element 15 in a sequential fashion, on the basis of the read-out pulses. The scope main unit 11 also comprises: an A/D converter 22 for inputting imaging signals output by the imaging element 15 and converting these signals to digital image data; a first memory (first storage means) 23 for storing imaging data for odd-numbered lines; a second memory (second storage means) 24 for storing imaging data for even-numbered lines; a mixing circuit 25; a memory control circuit 26; a first digital video processor (DVP) 27 and a third memory 28. Thereby, rather than being output as a two-line combined signal as in the prior art, the imaging signal output from the imaging element 15 is stored temporarily, in a state where it is divided into an imaging signal for the odd-numbered lines and an imaging signal for the even-numbered lines, in memories 23, 24 corresponding respectively to the same. Thereupon, the imaging data for the odd-numbered lines and the imaging data for the even-numbered lines is read out sequentially on the basis of the control implemented by the memory control circuit 26, and the mixing circuit 25 combines the imaging data for the odd-numbered lines and the imaging data for the even-numbered lines in such a manner that the pixels of each mutually correspond. The combined imaging data is subjected to prescribed signal processing by the DVP 27, whereupon it is stored in the third memory 28, and sequential scan imaging data is generated by reading out this data in a prescribed order (explained in detail hereinafter.) In other words, sequential scanning means 29 is constituted by the first memory 23, second memory 24, mixing circuit 25, memory control circuit 26 and DVP 27. FIG. 3 shows the contents of imaging data created by the circuitry from the imaging element 15 up to the third memory 28.

As illustrated in FIG. 3(A), the imaging element 15 comprises horizontal lines from line 1 to line N in accordance with the number of scanning lines, and is constituted in such a manner that the imaging data for these horizontal lines is read out by transferring it to transfer lines. The imaging data for the odd-numbered lines (lines 1, 3, 5, . . . ) of this imaging element 15 is stored in the first memory 23 illustrated in FIG. 3(B), and the imaging data for the even-numbered lines (lines 0, 2, 4, . . . ) of this imaging data is stored in the second memory 24 illustrated in FIG. 3(C).

The mixing circuit 25 carries out pixel binning of the imaging data in the memories 23, 24, in such a manner that the pixels in both lines, illustrated in FIG. 3(B) and FIG. 3(C), correspond with each other. In other words, aggregate data for the even-numbered lines and their subsequent odd-numbered lines, such as line 0+line 1, line 2+line 3, line 4+line 5, . . . is output as odd-numbered field data (pixel binned data for first combined line). Furthermore, pixel binning is carried out for the same lines as in FIG. 3(B) in a state where the read-out line in FIG. 3(C) has been shifted one line downwards (read out from position Cl indicated on diagram), whereby the aggregate data for the odd-numbered lines and their subsequent even-numbered lines, such as line 1+line 2, line 3+line 4, line 5+line 6, . . . is output as even-numbered field data (pixel binned data for second combined line).

The odd-numbered field data and even-numbered field data for which pixel binning has been carried out in this way is then subjected to colour signal processing based on a colour difference combining and read-out system, automatic gain control, y processing, and the like, in the DVP 27, and it is then stored temporarily in the third memory 28. By repeatedly reading out the field data in the third memory 28 in alternate sequence by switching the combined line number on the basis of the control implemented by the memory control circuit 26, this field data is converted to sequential scan imaging data for a single frame, as illustrated by FIG. 3(F). As the diagram reveals, the frame rate is half the field rate, and if the field cycle is 1/60th second, for example, then the frame cycle will be 1/30th second.

A second digital video processor (DVP) 28 which inputs sequential scan imaging data read out from the third memory 28 is provided in the processor section 12, which is connected after the scope main unit 11. In a DVP 28, outline enhancement processing, zoom (enlargement/reduction) processing, image position control, mirror image processing, and the like, is carried out. After this DVP 28, there are connected scan converting means 32 and a D/A converter 33 for generating sequential scan image data for a personal computer interface, etc., or interlace scan image data for TV systems. Thereby, sequential scan imaging data is converted by scan converting means 32 to data for a PC or TV, and this data is then converted to an analogue image signal by D/A converter 33 and output.

Moreover, a light source 35 is provided in the light source device 13, which is connected to the light guide 16 contained in the scope end section 10, and an optical chopper 36 and iris 37 forming one mode of exposure control means are positioned between the light source 35 and the input end of the light guide 16. The optical chopper 36 has, for example, a structure wherein a semicircular plate is caused to rotate, and a drive circuit 38 and servo circuit 39 are connected in order to rotate this optical chopper 36 through one revolution in 1/30th second. Therefore, by means of this optical chopper 36, in the field O/E signal (O: odd field; E: even field) having a 1/60th second cycle, the imaging element 15 can be exposed for 1/60th second only and then put into a non-exposed state during the subsequent 1/60th second time period.

The iris 37, on the other hand, is connected to a drive circuit 40 and an iris control circuit 41, and by driving the iris 37 by means of this drive circuit and iris control circuit 41 on the basis of a brightness signal obtained from the first digital video processor (not illustrated) (in FIG. 1, it is described as an output from

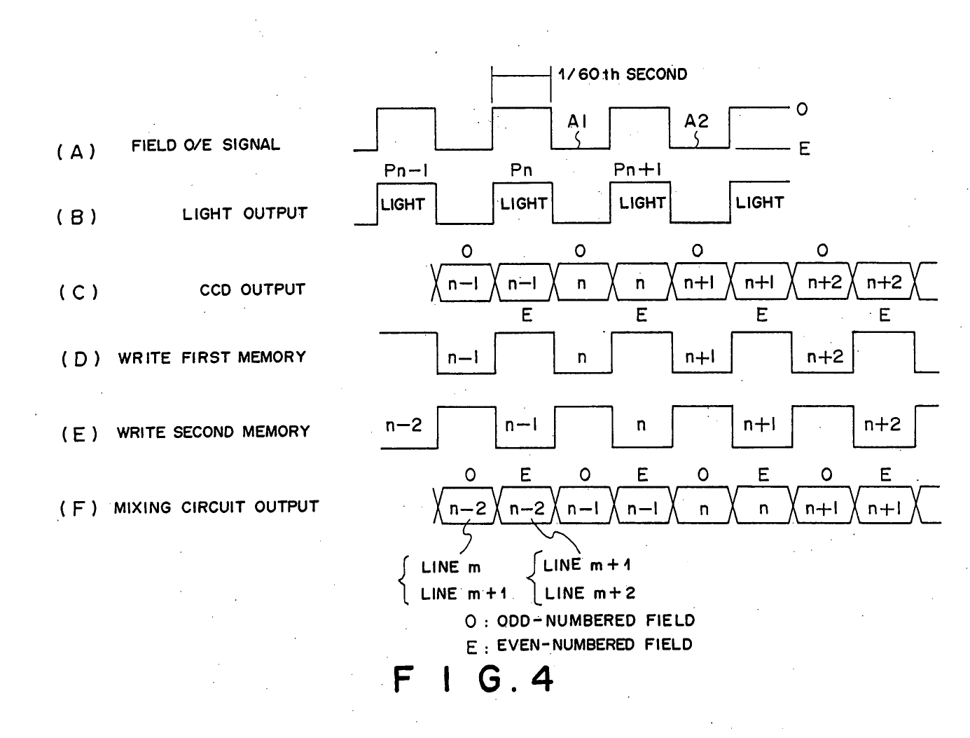

the memory 27), it is possible to adjust the amount of light to which the imaging element 15 is exposed. Next, the action of the electronic endoscope device 1 having the foregoing composition is described with reference to FIG. 4.

As shown in FIG. 4(A), a timing signal for creating one field in 1/60th second is used as a field O/E signal, similarly to a conventional device. Correspondingly, the optical chopper 36 is caused to rotate at 1/30th second per revolution, whereby light is repeatedly injected into the light guide 16 for time periods of 1/60th second separated by light shielding intervals of 1/60th second, as illustrated by Pₙ₋₁, Pₙ, Pₙ₊₁ in FIG. 4(B). This light is directed via the light guide 16 to the top of the scope end section 10, and the inside of the object under examination is thereby illuminated.

By means of this illumination, an image of the inside of the object under examination is captured by the imaging element 15 provided in the scope end section 10, and electrical charge corresponding to the image is accumulated in the imaging element 15. This electrical charge is read out on the basis of control pulses from the pulse output circuit 18, and in cases where an electronic shutter function is used, the timing of charge accumulation or read-out can be changed by means of the control pulses, thereby making it possible to vary the charge accumulation time period and to adjust the amount of exposure light.

Thereupon, in the present example, the accumulated electrical charge for all pixels in the imaging element 15 gathered in one exposure cycle is read out under the control of the all-pixel read-out pulse generating circuit 19. In other words, an imaging signal for the odd-numbered lines of field number n−1 and an imaging signal for the even-numbered lines thereof are read out successively from the imaging element 15, on the basis of the exposure light of light illumination Pₙ₋₁ in FIG. 4(B), and after both signals have been digitally converted by the A/D converter 22, the imaging signal for the odd-numbered lines is stored in the first memory 23 in accordance with the write signal illustrated by FIG. 4(D) and, similarly, the imaging signal for the even-numbered lines is stored in the second memory 24 in accordance with the write signal illustrated by FIG. 4(E). Thereafter, the corresponding imaging signals for the odd-numbered and even-numbered lines are read out from the imaging element 15 in the sequence of light illumination Pₙ, Pₙ₊₁, and are stored in the corresponding memories 23, 24.

Thereupon, as illustrated in FIG. 4(F), the data in the memories 23, 24 is combined pixel by pixel by the mixing circuit 25, in such a manner that combined pixel field data is successively created. For example, number n−2 odd-numbered field data are obtained by mixing combinations of pixels corresponding respectively to imaging data for even-numbered lines (2m) and imaging data for the subsequent odd-numbered lines (2m+1) in field number n−2 (binning line 2m+1), number n−2 even-numbered field data are obtained by mixing combinations of pixels corresponding respectively to imaging data for odd-numbered lines (2m+1) and imaging data for the subsequent even-numbered lines (2m+2) in field number n−2 (binning line 2m+2), number n−1 odd-numbered field data are obtained by mixing combinations of pixels corresponding respectively to imaging data for even-numbered lines (2m) and imaging data for the subsequent odd-numbered lines (2m+1) in field number n−1 (binning line 2m+1), and so on. The odd-numbered field data and even-numbered field data which has undergone pixel binning in this manner then undergoes prescribed signal processing, such as colour signal processing, or the like, by means of the DVP 27, whereupon it is stored temporarily in the third memory 28.

Thereupon, both sets of field data stored in the third memory 28 are read out repeatedly in alternate fashion by successively changing the binning line, 1, 2, 3, . . . , for the same number field data, for example, number n−2 field data, thereby creating sequential scan imaging data for frame number n−2 (corresponding to the imaging data shown in FIG. 3(F)). Sequential scan imaging data for successive frames is created similarly by progressively changing the field data used, from number n−1, . . . .

In the foregoing description, odd-numbered field data and even-numbered field data which had undergone pixel binning was stored temporarily in the third memory 28, data being read out from the third memory 28 in such a manner that sequential scan imaging data was obtained, but besides this, rather that forming separate field data which have undergone pixel binning, it is also possible, for example, to form sequential scan imaging data directly by carrying out pixel binning and sequential scan processing in parallel, from binning line 2m+1, 2m+2, . . . , whereupon colour signal processing, and the like, is applied to the sequential scan imaging data.

The sequential scan imaging data created in this way is input to the DVP 28. In the DVP 28, treatments such as outline enhancement, zoom (enlargement/reduction) processing, image position control, mirror image processing, and the like, are carried out. In other words, these treatments are carried out by using data for the adjacent line or the next to adjacent line in the sequential scan. Therefore, in contrast to conventional devices where data for adjacent lines cannot be used and hence coarse image processing is obtained, when an image is viewed as a frame image, according to the present invention, the aforementioned treatments are carried out by using data for adjacent lines in the frame image, and consequently there is no generation of image distortion even in detailed areas and problems of deterioration in image quality are resolved. The actual treatment methods for outline enhancement processing, zoom processing, and the like, are similar to those used in a conventional device, the only difference being whether the adjacent line data used in the treatments is adjacent line data for a field image, or adjacent line data for a frame image, and since these treatments involve commonly known techniques, they are not described in detail here.

The sequential scan imaging data having undergone outline enhancement processing, and the like, in the DVP 28 is input to the scan converting means 32. The scan converting means 32 creates image data for sequential scanning (progressive or non-interlaced scanning) for personal computer interfaces, and the like, or image data for interlaced scanning for TV systems, and the like. In specific terms, the foregoing example involves sequential scan imaging data having a frame rate of 1/30th second, and this is either converted to sequential scan image data having a frame rate of 1/60th second, or it is converted to interlaced scan image data having a field rate of 1/60th second and a frame rate of 1/30th second. The method for converting sequential scan imaging data into sequential scan image data having a different frame rate and the method for converting sequential scan imaging data into interlaced scan image data both involve commonly known techniques, and since these commonly known techniques can be used in the present invention, they are not described in detail here.

The foregoing description related to a method where pixel binning is applied, but the present invention is not necessarily limited to this. Namely, provided that an imaging element is used which comprises a plurality of pixels arranged in a plurality of lines and is capable of reading out an imaging signal captured by means of the pixels for each line, then the invention can be applied to any kind of device. For example, it is possible to use a black and white imaging element, or an imaging element using a green-check RGB primary colour filter array, as typified by the aforementioned Bayer system. The mode is described below.

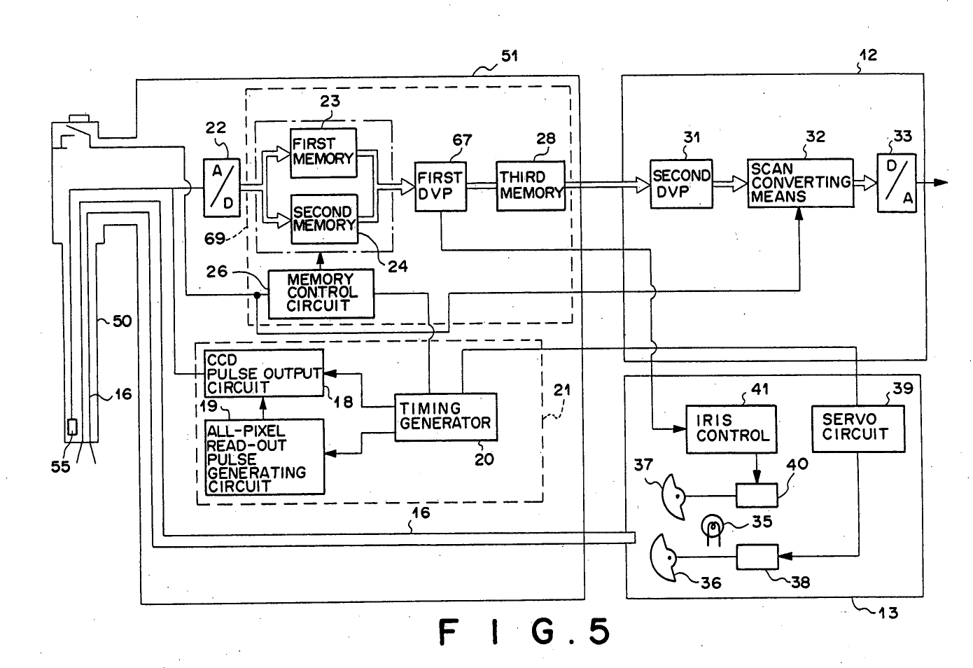

FIG. 5 is a block diagram of an electronic endoscope device 2 using an imaging element wherein a Bayer-type primary colour filter array is positioned.

As shown in FIG. 5, the electronic endoscope device 2 comprises a scope end section 50, a scope main unit 51, a processor section 12 and a light source section 13. The scope end section 50 and the scope main unit 51 are different to those in the electronic endoscope device 1 described above.

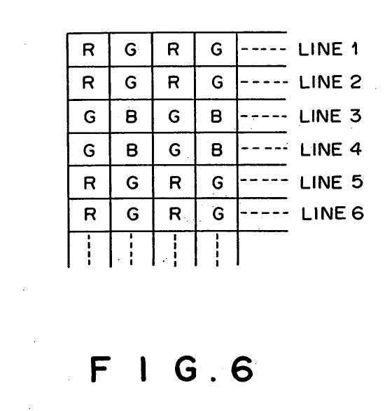

A CCD imaging element 55 comprising a Bayer-type primary colour filter array is provided in the scope end section 50. The CCD imaging element 55 contains a plurality of pixels arranged in a plurality of lines, and a plurality of colour filters having the arrangement configuration illustrated in FIG. 6, which are arrayed in pixel units. In other words, R (red), G (green) and B (blue) are positioned in pixel units, as illustrated in FIG. 6, and the imaging element is able to read out imaging signals captured by means of the pixels in accordance with a control system of drive pulses, line by line.

The scope main unit 51 is different to the scope main unit 11 in the aforementioned device 1 in that it does not comprise a mixing circuit and it is provided with DVP 67 in place of DVP 27. In the present example, the imaging signal output from the imaging element 55 is stored temporarily, in a state where it is divided into an imaging signal for the odd-numbered lines and an imaging signal for the even-numbered lines, in memories 23, 24 corresponding respectively to the same. The imaging data for the odd-numbered lines and the imaging data for the even-numbered lines are then read out successively on the basis of the control implemented by the memory control circuit 26, and the imaging data thus read out is subjected to prescribed signal processing by DVP 67 and then stored in the third memory 28, whereupon it is read out in a prescribed sequence, thereby generating sequential scan imaging data (details described hereinafter). In other words, in the present example, sequential scanning means 69 is constituted by the first memory 23, second memory 24, memory control circuit 26 and DVP 66.

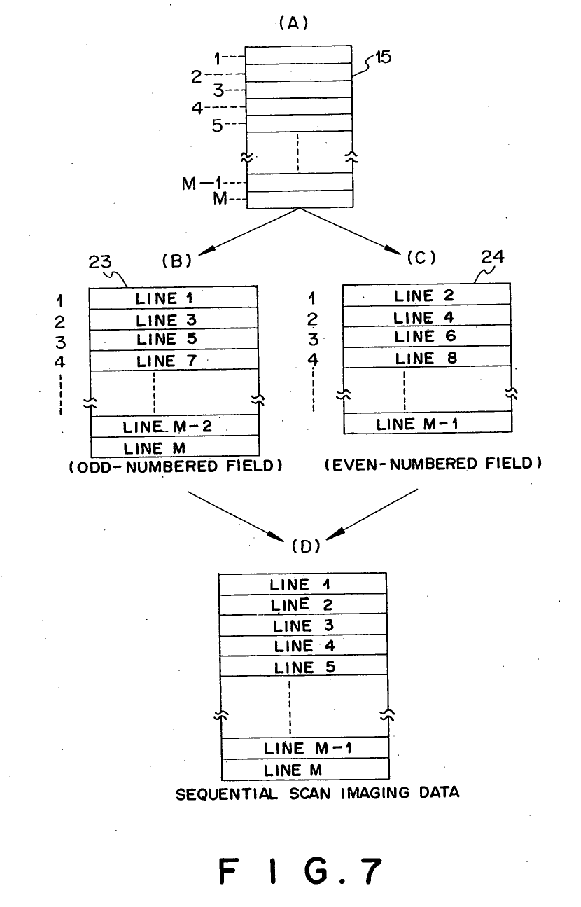

FIG. 7 shows the contents of image data created by the circuitry from the imaging element 55 up to the third memory 28 in the present example.

As shown in FIG. 7(A), horizontal lines are provided in the imaging element 55 from line 1 to line M in accordance with the number of scanning lines, and the element is constituted in such a manner that the imaging data for these horizontal lines is read out by being transferred to transfer lines. The imaging data for the odd-numbered lines (lines 1, 3, 5, . . . ) of the imaging element 55 is stored in the first memory 23 shown in FIG. 7(B) as odd-numbered field data, and the imaging data for the even-numbered lines (lines 2, 4, 6, . . . ) is stored in the second memory 24 shown in FIG. 7(C) as even-numbered field data.

The odd-numbered field data and even-numbered field data stored in the memories 23, 24 undergoes Bayer-system colour signal processing, automatic gain control, γ processing, and the like, and is then stored in the third memory 28. The groups of field data in the third memory 28 are repeatedly read out in alternate sequence on the basis of control implemented by the memory control circuit 26, thereby converting the field data to sequential scan imaging data for a single frame, as illustrated in FIG. 7(D).

Therefore, in the present example, similarly to device 1 described above, since sequential scan imaging data is created, no problems of deterioration in image quality arise when outline enhancement processing, zoom processing, and the like, is carried out on the basis of this sequential scan imaging data. Moreover, it is of course also possible to create sequential scan image data for personal computer interfaces, and the like, and interlaced scan image data for TV systems.

The foregoing descriptions related to cases where the imaging device according to the present invention was applied to an electronic endoscope, but the invention is not limited to this, and may of course be applied to imaging devices of any kind. Moreover, the invention is not limited to devices capturing moving images, but may also be applied to devices capturing stationary images, for example, digital cameras, which have become remarkably widespread at the present time, or the like.

1. An imaging device comprising:
an imaging element, wherein a plurality of pixels are arranged in a plurality of lines, which is capable of reading out imaging signals captured by means of said pixels, line by line;
light exposure controlling means for alternately repeating steps of exposure and non-exposure of said imaging element to light;
driving means for driving said imaging element in such a manner that an imaging signal is output for the pixels in each line of one of either the odd-numbered lines or the even-numbered lines, from the pixels in said plurality of lines, for a prescribed time period after said exposure, whereupon an imaging signal is output for the pixels in each line of the other of either the odd-numbered lines or the even-numbered lines, before the subsequent exposure;
first storing means for storing an imaging signal for each of said one group of lines;
second storing means for storing an imaging signal for each of said other group of lines;
sequential scanning means for obtaining a sequential scan imaging signal by repeatedly reading out the imaging signal for each line stored in said first storing means and the imaging signal for each line stored in said second storing means, in alternating sequence; and
a third storing means for storing said sequential scan imaging signal.

2. An imaging device comprising:
an imaging element for capturing colour images, wherein a plurality of pixels are arranged in a plurality of lines and a plurality of colour filters for pixel binning are positioned in units of said pixels, which is capable of reading out imaging signals captured by means of said pixels, line by line;
light exposure controlling means for alternately repeating steps of exposure and non-exposure of said imaging element to light;
driving means for driving said imaging element is such a manner that an imaging signal is output for the pixels in each line of one of either the odd-numbered lines or the even-numbered lines, from the pixels in said plurality of lines, for a prescribed time period after said exposure, whereupon an imaging signal is output for the pixels in each lines of the other of either the odd-numbered lines or the even-numbered lines, before the subsequent exposure;
first storing means for storing an imaging signal for each of said one set of lines;
second storing means for storing an imaging signal for each of said other set of lines;
sequential scanning means for obtaining a sequential scan imaging signal by repeatedly using, in alternating sequence, a pixel-binned signal for a first binning line, wherein the imaging signal for the pixels of each even-numbered line is combined with the imaging signal for the pixels of each subsequent odd-numbered line which correspond to the pixels of said even-numbered line, and a pixel-binned signal for a second binning line, wherein the imaging signal for the pixels of each odd-numbered line is combined with the imaging signal for the pixels of each subsequent even-numbered line which correspond to the pixels of said odd-numbered line; and
a third storing means for storing said sequential scan imaging signal.

3. The imaging device according to claim 1 or claim 2, further comprising outline enhancement processing means for implementing outline enhancement processing on the basis of said sequential scan imaging signal.

4. The imaging device according to claim 1 or claim 2, further comprising enlargement and reduction processing means for implementing enlargement and reduction processing of the image on the basis of said sequential scan imaging signal.

5. The imaging device according to claim 1 or claim 2, further comprising scan converting means for generating a sequential scan image signal for a personal computer interface, or the like, or an interlaced scan image signal for a TV system, or the like, on the basis of said sequential scan imaging signal.
